(19) United States
(12) Patent Application Publication
(10) Pub. No.: US 2008/0263347 A1
(43) Pub. Date: Oct. 23, 2008

(54) NETWORK DEVICE AND REBOOTING METHOD THEREOF

(75) Inventor: SHIH-PIN CHEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/967,112

(22) Filed: Dec. 29, 2007

(30) Foreign Application Priority Data
Apr. 17, 2007 (CN) 200710200468.5

(51) Int. Cl. G06F 15/177; G06F 9/44

(52) U.S. Cl. 713/2; 717/168

(57) ABSTRACT

A network device connected to a server includes a firmware upgrading determining module, a communication module, a storage module, a reboot determining module, and a reboot scheduling module. The firmware upgrading determining module determines whether current firmware of the network device needs to be upgraded. The communication module downloads the newest firmware from the server, and upgrades the current firmware if the current firmware needs to be upgraded. The storage module saves a reboot flag and a preset reboot time window. The reboot determining module determines whether the network device needs to be rebooted immediately according to the reboot flag, and determines whether the network device has a preset reboot time window. The reboot scheduling module determines what time to reboot during the reboot time window if the network device does not need to be rebooted immediately and the network device has a preset reboot time window.

### BACKGROUND OF THE INVENTION

1. Field of the Invention

The invention relates to network devices, and particularly to a network device and rebooting method after a firmware upgrade thereof.

2. Description of Related Art

More and more network devices, such as modems and other terminal devices, utilize embedded systems, such as upgradeable firmware.

Conventionally, network devices are rebooted immediately after their firmware is upgraded. However, if the network device is a modem, and a user is connected to the Internet by the modem, the reboot of the modem will stop the network connection of the user, which is inconvenient for the user.

### SUMMARY OF THE INVENTION

In one aspect of the invention, a network device connected to a server providing the newest firmware for the network device and a version number of the newest firmware is provided. The network device includes a firmware upgrading determining module, a communication module, a storage module, a reboot determining module, and a reboot scheduling module. The firmware upgrading determining module is used for determining whether current firmware of the network device needs to be upgraded. The communication module connected to the firmware upgrading determining module is used for downloading the newest firmware from the server and upgrading the current firmware of the network device if the current firmware of the network device needs to be upgraded. The storage module is used for saving a reboot flag and a preset reboot time window, the reboot flag representing whether the network device needs to be rebooted immediately after a firmware upgrade. The reboot determining module connected to the communication module and the storage module is used for determining whether the network device needs to be rebooted immediately after the firmware upgrade according to the reboot flag saved in the storage module, and determining whether the network device has a preset reboot time window if the network device does not need to be rebooted immediately. The reboot scheduling module connected to the reboot determining module and the storage module is used for determining what time to reboot the network device during the reboot time window if the reboot determining module determines that the network device does not need to be rebooted immediately and the network device has a preset reboot time window.

Other advantages and novel features will become more apparent from the following detailed description when taken in conjunction with the accompanying drawings.

### BRIEF DESCRIPTION OF THE DRAWINGS

FIG. 1 is a schematic diagram of a network device of an exemplary embodiment of the invention.

FIG. 2 is a flowchart of a rebooting method of the network device of another exemplary embodiment of the invention.

FIG. 3 and FIG. 4 are flowcharts of a rebooting method of the network device of a further exemplary embodiment of the invention.

### DETAILED DESCRIPTION OF THE INVENTION

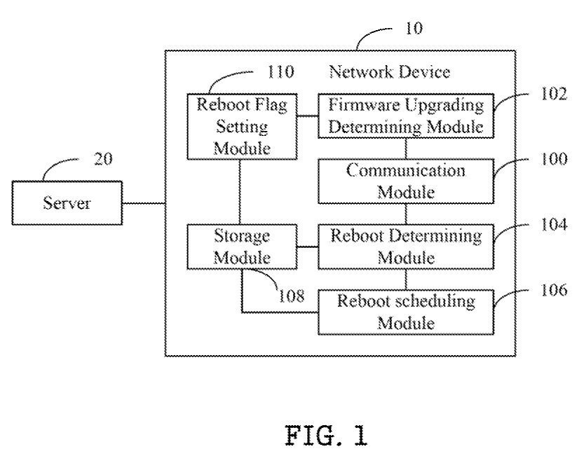

FIG. 1 is a schematic diagram of a network device 10 of an exemplary embodiment of the invention. The network device 10 communicates with a server 20 for retrieving the newest firmware for the network device 10 and a version number of the newest firmware. In the exemplary embodiment, the network device 10 may be customer premise equipment or a personal computer. The network device 10 may be a dynamic host configuration protocol (DHCP) client, the server 20 may be a DHCP server providing the newest firmware for the network device 10, and the network device 10 is also used for retrieving Internet protocol (IP) addresses from the server 20. In alternative exemplary embodiments, the network device 10 and the server 20 may be utilized in other systems.

In the exemplary embodiment, the network device 10 includes a communication module 100, a firmware upgrading determining module 102, a reboot determining module 104, a reboot scheduling module 106, a storage module 108, and a reboot flag setting module 110.

The communication module 100 communicates with the server 20 for retrieving IP addresses and the version number of the newest firmware for the network device 10 from the server 20. The firmware upgrading determining module 102 is connected to the communication module 100, and is used for determining whether current firmware of the network device 10 needs to be upgraded. In the exemplary embodiment, the firmware upgrading determining module 102 compares the version number of the newest firmware retrieved by the communication module 100 with a version number of the current firmware of the network device 10 to determine whether the current firmware of the network device 10 needs to be upgraded. If the version number of the newest firmware retrieved by the communication module 100 is different from the version number of the current firmware of the network device 10, the current firmware of the network device 10 needs to be upgraded. If the version number of the newest firmware retrieved by the communication module 100 is the same as the version number of the current firmware of the network device 10, the current firmware of the network device 10 does not need to be upgraded. If the current firmware of the network device 10 needs to be upgraded, the communication module 100 downloads the newest firmware from the server 20 to upgrade the current firmware of the network device 10.

The storage module 108 is used for saving a reboot flag and a preset reboot time window. In the exemplary embodiment, the reboot flag represents whether the network device 10 needs to be upgraded immediately after a firmware upgrade. If the network device 10 needs to be rebooted immediately after the firmware upgrade, the reboot flag is set to “0.” If the network device 10 does not need to be rebooted immediately after the firmware upgrade, the reboot flag is set to “1.” In other exemplary embodiments, the reboot flag may be set to other numerals or even letters. In the exemplary embodiment, when the network device 10 is turned on, the reboot flag is “0,” that is, the network device 10 needs to be rebooted immediately after the firmware upgrade. The preset reboot time window defines a reboot time window for when the network device 10 can be rebooted if the network device does not need to be rebooted immediately after the firmware upgrade, for example, 1:00 AM to 3:00 AM.

The reboot flag setting module 110 is connected to the firmware upgrading determining module 102 and the storage module 108, and is used for setting the reboot flag to “1,” indicating that the network device 10 does not need to be rebooted immediately after the firmware upgrade, after the firmware upgrading determining module 102 first determines that the current firmware of the network device 10 does not need to be upgraded when the network device 10 is turned on, and for saving the reboot flag in the storage module 108.

The reboot determining module 104 is used for determining whether the network device 10 needs to be rebooted immediately after the firmware upgrade. In the exemplary embodiment, the reboot determining module 104 checks the storage module 108 for the reboot flag, and determines whether the network device 10 needs to be rebooted immediately according to the reboot flag. The reboot determining module 104 is further used for determining whether the network device 10 has a preset reboot time window if the network device 10 does not need to be rebooted immediately after the firmware upgrade. The reboot determining module 104 checks the storage module 108 for the preset reboot time window saved therein to determine whether the network device 10 has a preset reboot time window.

The reboot scheduling module 106 is connected to the reboot determining module 104 and the storage module 108, and is used for determining what time to reboot the network device 10 during the preset reboot time window according to a media access control (MAC) address and the preset reboot time window if the reboot determining module 104 determines that the network device 10 has a reboot time window, for determining whether it is time to reboot the network device 10, and for rebooting the network device 10 if it is time to reboot. In the exemplary embodiment, the reboot scheduling module 106 calculates a reboot time of the network device 10 using an srand function and a rand function. First, the reboot scheduling module 106 generates a seed according to the MAC address. The reboot scheduling module 106 takes the MAC address and performs a shift left one bit operation, and then takes a total of the result to generate the seed. The reboot scheduling module 103 then performs the srand function according to the seed, and finally performs the rand function to generate the reboot time. Thus, the reboot time of each network device 10 is different according to the MAC address, which decreases network load by avoiding simultaneous reboot of several network devices 10.

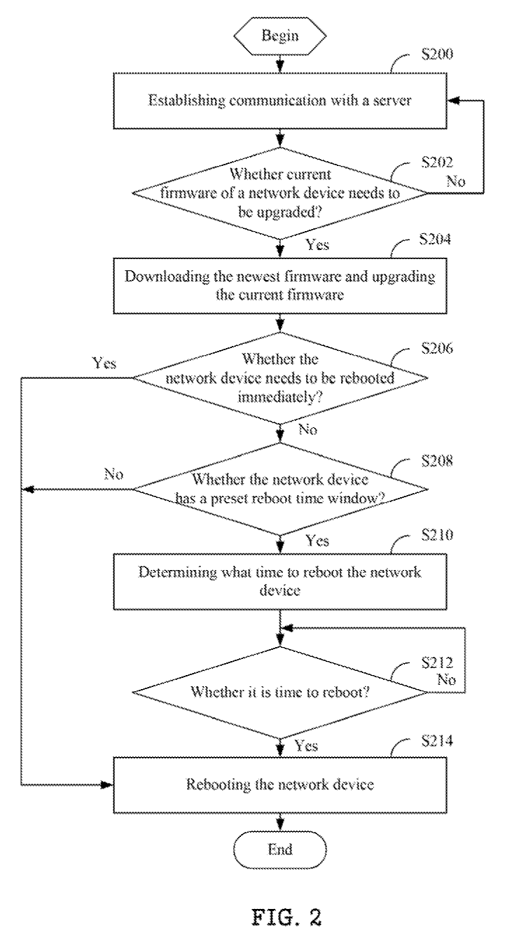

FIG. 2 is a flowchart of a rebooting method of the network device 10. In the exemplary embodiment, the network device 10 may be a terminal device or a personal computer. In step S200, the communication module 100 communicates with the server 20 that provides the newest firmware for the network device 10, and retrieves a version number of the newest firmware. In step S202, the firmware upgrading determining module 102 determines whether current firmware of the network device 10 needs to be upgraded. In the exemplary embodiment, the firmware upgrading determining module 102 compares the version number of the newest firmware retrieved by the communication module 100 with a version number of the current firmware of the network device 10, if they don't match, the network device 10 needs to be upgraded.

If the current firmware of the network device 10 does not need to be upgraded, the process turns to step S200, the network device 10 communicates with the server 20 normally.

If the current firmware of the network device 10 needs to be upgraded, in step S204, the communication module 200 downloads the newest firmware from the server 20, and upgrades the current firmware of the network device 10. In step S206, the reboot determining module 104 determines whether the network device 10 needs to be rebooted immediately. In the exemplary embodiment, the reboot determining module 104 determines whether the network device 10 needs to be rebooted immediately according to the reboot flag saved in the storage module 108. If the reboot flag is “0,” the network device 10 needs to be rebooted immediately; if the reboot flag is “1,” the network device 10 does not need to be rebooted immediately.

If the reboot determining module 104 determines that the network device 10 needs to be rebooted immediately, in step S214, the network device 10 is rebooted.

If the reboot determining module 104 determines that the network device 10 does not need to be rebooted immediately, in step S208, the reboot determining module 104 further determines whether the network device 10 has a preset reboot time window. In the exemplary embodiment, the reboot determining module 104 checks the storage module 108 to determine whether the network device 10 has a preset reboot time window.

If the network device 10 does not have a preset reboot time window, in step S214, the network device 10 is rebooted.

If the network device 10 has a preset reboot time window, in step S210, the reboot scheduling module 106 determines what time to reboot the network device 10 during the preset reboot window. In the exemplary embodiment, the reboot scheduling module 106 calculates a reboot time of the network device 10 as detailed above in paragraph 15.

In step S212, the reboot scheduling module 106 continually checks whether it is time to reboot the network device 10. When it is time to reboot, in step S214, the network device 10 is rebooted.

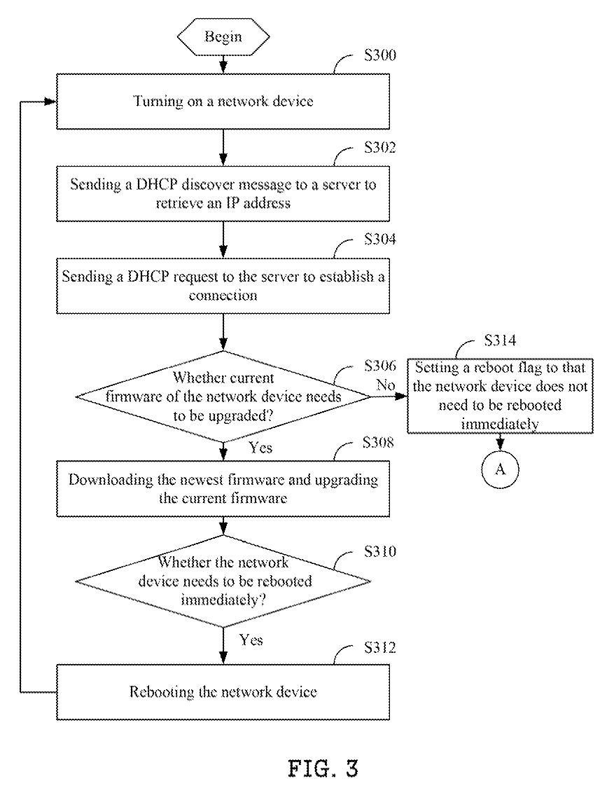

FIG. 3 is a flowchart of a rebooting method of the network device 10 of another exemplary embodiment of the invention. In the exemplary embodiment, the network device 10 is a DHCP client. In step S300, the network device 10 is turned on. In step S302, the communication module 100 of the network device 10 sends a DHCP discover message to the server 20 to retrieve an IP address. In step S304, the communication module 100 sends a DHCP request to the server 20 to establish a connection therebetween, and retrieves a version number of the newest firmware for the network device 10 from the server 20.

In step S306, the firmware upgrading determining module 102 determines whether current firmware of the network device 10 needs to be upgraded. In the exemplary embodiment, the firmware upgrading determining module 102 compares the version number of the newest firmware retrieved by the communication module 100 and a version number of the current firmware of the network device 10 to determine whether the current firmware of the network device 10 needs to be upgraded.

If the current firmware of the network device 10 does not need to be upgraded, in step S314, the reboot flag setting module 110 sets a reboot flag to “1,” indicating that the network device 10 does not need to be rebooted immediately, and saves the set reboot flag in the storage module 108.

If the current firmware of the network device 10 needs to be upgraded, in step S308, the communication module 100 downloads the newest firmware from the server 20, and upgrades the current firmware of the network device 10. Then the process goes to step S310, the reboot determining 104 determines whether the network device 10 needs to be rebooted immediately. In the exemplary embodiment, the reboot determining module 104 determines whether the network device 10 needs to be rebooted immediately according to the reboot flag saved in the storage module 108. If the reboot flag is “0,” the network device 10 needs to be rebooted immediately; if the reboot flag is “1,” the network device 10 does not need to be rebooted immediately. However, when the network device 10 is just turned on, an initial reboot flag is set to “0,” indicating that the network device 10 needs to be rebooted immediately. Therefore, in step S310, the reboot determining module 104 can only determine that the network device 10 needs to be rebooted immediately. In step S312, the network device 10 is rebooted.

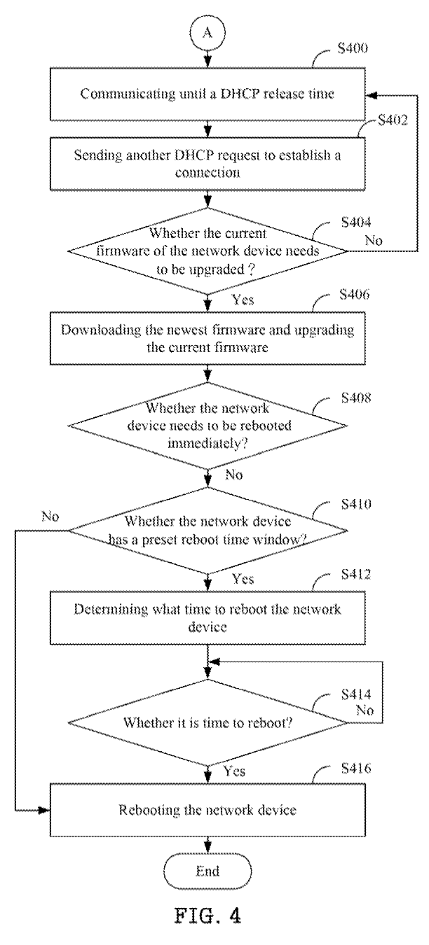

FIG. 4 is a flowchart of the rebooting method after step S314 of FIG. 3. In step S400, the network device 10 communicates with the server 20 until release. In step S402, the communication module 100 of the network device 10 sends another DHCP request to the server 20 to establish a connection therebetween, and retrieves a version number of the newest firmware for the network device 10 saved in the server 20. In step S404, the firmware upgrading determining module 102 determines whether the current firmware of the network device 10 needs to be upgraded. In the exemplary embodiment, the firmware upgrading determining module 102 compares the version number of the newest firmware retrieved by the communication module 100 and the version number of the current firmware of the network device 10 to determine whether the current firmware of the network device 10 needs to be upgraded.

If the current firmware of the network device 10 does not need to be upgraded, the process turns to step S400, the network device 10 communicates with the server 20 until release.

If the current firmware of the network device 10 needs to be upgraded, in step S406, the communication module 100 downloads the newest firmware from the server 20, and upgrades the current firmware of the network device 10.

In step S408, the reboot determining 104 determines whether the network device 10 needs to be rebooted immediately. In the exemplary embodiment, the reboot determining module 104 determines whether the network device 10 needs to be rebooted immediately according to the reboot flag saved in the storage module 108. If the reboot flag is “0,” the network device 10 needs to be rebooted immediately; if the reboot flag is “1,” the network device 10 does not need to be rebooted immediately. However, in step S314, the reboot flag is set to “1,” indicating that the network device 10 does not need to be rebooted immediately. Therefore, in step S408, the reboot determining module 104 can only determine that the network device 10 does not need to be rebooted immediately.

In step S410, the reboot determining module 104 determines whether the network device 10 has a preset reboot time window. In the exemplary embodiment, the reboot determining module 104 checks the storage module 108 to determine whether the network device 10 has a preset reboot time window.

If the network device 10 does not has a preset reboot time window, in step S416, the network device 10 is rebooted.

If the network device 10 has a preset reboot time window, in step S412, the reboot scheduling module 106 determines what time to reboot the network device 10 during the preset reboot time window according to an MAC address of the network device 10 and the preset reboot time window.

Then in step S414, the reboot scheduling module 106 continually checks whether it is time to reboot the network device 10. When it is time to reboot, the network device 10 is rebooted.

The rebooting method of FIGS. 3 and 4 can be utilized in other devices such as PCs. Then in steps S302 and S304, the network device 10 may retrieve the IP address, and communicate with the server 20 by other protocols; steps S400 and S402 can be omitted; step S404 can operate periodically, for example, the firmware upgrading determining module 102 only checks once every twelve hours if upgrading must be done.

The network device 10 and the rebooting method thereof can avoid inconvenience resulted by immediate reboot, and decrease network load by avoiding simultaneous reboot of several network devices 10.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A network device, connected to a server providing newest firmware for the network device and a version number of the newest firmware, comprising:
a firmware upgrading determining module, for determining whether current firmware of the network device needs to be upgraded;
a communication module connected to the firmware upgrading determining module, for downloading the newest firmware from the server and upgrading the current firmware of the network device if the current firmware of the network device needs to be upgraded;
a storage module, for saving a reboot flag and a preset reboot time window, the reboot flag representing whether the network device needs to be rebooted immediately after a firmware upgrade;
a reboot determining module connected to the communication module and the storage module, for determining whether the network device needs to be rebooted immediately after the firmware upgrade according to the reboot flag saved in the storage module, and determining whether the network device has a preset reboot time window if the network device does not need to be rebooted immediately; and
a reboot scheduling module connected to the reboot determining module and the storage module, for determining what time to reboot the network device during the preset reboot time window if the reboot determining module determines that the network device does not need to be rebooted immediately and the network device has a preset reboot time window.

2. The network device of claim 1, wherein the communication module is further used for retrieving the version number of the newest firmware for the network device from the server.

3. The network device of claim 2, wherein the firmware upgrading determining module compares the version number of the newest firmware of the network device with a version number of the current firmware of the network device to determine whether the current firmware of the network device needs to be upgraded.

4. The network device of claim 1, further comprising a reboot flag setting module connected to the firmware upgrading determining module and the storage module, for setting the reboot flag to indicate that the network device does not need to be rebooted immediately after the firmware upgrade, after the firmware upgrading determining module first determines that the current firmware of the network device does not need to be upgraded when the network device is turned on, and for saving the reboot flag in the storage module.

5. The network device of claim 1, wherein the reboot determining module checks the storage module to determine whether the network device has a preset reboot time window.

6. The network device of claim 1, wherein the reboot scheduling module determines what time to reboot the network device during the preset reboot time window according to a media access control address of the network device and the preset reboot time window.

7. The network device of claim 1, wherein the reboot scheduling module is further used for determining whether it is time to reboot the network device and making the network device reboot if it is time to reboot.

8. A rebooting method of a network device, comprising:
establishing communication with a server that provides the newest firmware for the network device;
determining whether current firmware of the network device needs to be upgraded;
downloading the newest firmware for the network device from the server, and upgrading the current firmware if the current firmware of the network device needs to be upgraded;
determining whether the network device needs to be rebooted immediately after a firmware upgrade;
determining whether the network device has a preset reboot time window if the network device does not need to be rebooted immediately;
determining what time to reboot the network device during the preset reboot time window if the network device has a preset reboot time window;
determining whether it is time to reboot the network device; and
rebooting the network device if it is time to reboot.

9. The rebooting method of claim 8, wherein the step of determining whether current firmware of the network device needs to be upgraded comprises steps of:
retrieving a version number of the newest firmware for the network device from the server; and
comparing the version number of the newest firmware with a version number of the current firmware of the network device to determine whether the current firmware of the network device needs to be upgraded.

10. The rebooting method of claim 8, wherein the step of determining whether the network device needs to be rebooted immediately comprises steps of:
checking a storage module for a reboot flag therein to determine whether the network device needs to be rebooted immediately.

11. The rebooting method of claim 10, wherein the reboot flag represents whether the network device needs to be rebooted immediately after the firmware upgrade.

12. The rebooting method of claim 8, wherein the step of determining whether the network device has a preset reboot time window comprises steps of:
checking a storage module to determine whether the network device has a preset reboot time window.

13. The rebooting method of claim 8, wherein the step of determining what time to reboot the network device during the preset reboot time window comprises steps of:
determining what time to reboot the network device during the preset reboot time window according to the preset reboot time window and a media access control address of the network device.

14. A method of rebooting a network device, comprising:
upgrading a current firmware of said network device if said current firmware of said network device needs to be upgraded;
determining whether the network device needs to be rebooted immediately after upgrading said current firmware;
determining a time to reboot said network device if said network device does not need to be rebooted immediately; and
rebooting said network device if it is time to reboot.

15. The method of claim 14, further comprising determining whether said network device has a preset reboot time window if said network device does not need to be rebooted immediately.

16. The method of claim 14, wherein said time determined to reboot said network device is set according to an MAC address of said network device.
